(19) United States
(12) Patent Application Publication
(10) Pub. No.: US 2024/0160612 A1
(43) Pub. Date: May 16, 2024

(54) SCHEDULING METHOD BASED ON TASK ANALYSIS IN MULTIPLE COMPUTATIONAL STORAGE DBMS ENVIRONMENT

(71) Applicant: Korea Electronics Technology Institute, Seongnam-si (KR)

(72) Inventors: Jae Hoon AN, Incheon (KR); Young Hwan KIM, Yongin-si (KR); Ri A CHOI, Seongnam-si (KR)

(73) Assignee: Korea Electronics Technology Institute, Seongnam-si (KR)

(21) Appl. No.: 18/387,626

(22) Filed: Nov. 7, 2023

(30) Foreign Application Priority Data
Nov. 11, 2022 (KR) 10-2022-0150074

(51) Int. Cl. G06F 16/21; G06F 9/48

(52) U.S. Cl. CPC G06F 16/217; G06F 9/4881

(57) ABSTRACT

There is provided a method for dividing query computations and scheduling for CSDs in a DB system in which a plurality of CSDs are used as a storage. A scheduling method according to an embodiment includes: selecting one of a plurality of scheduling polices; selecting a CSD to which snippets included in a group are delivered according to the selected scheduling policy; and delivering the snippets to the selected CSD, and the scheduling polices are polices for selecting CSDs to which snippets are delivered, based on different criteria. Accordingly, CSDs may be randomly selected according to user setting or a query execution environment, or an optimal CSD may be selected according to a CSD status or a content of an offload snippet, so that a query execution speed can be enhanced.

### CROSS-REFERENCE TO RELATED APPLICATION(S) AND CLAIM OF PRIORITY

This application is based on and claims priority under 35 U.S.C. § 119 to Korean Patent Application No. 10-2022-0150074, filed on Nov. 11, 2022, in the Korean Intellectual Property Office, the disclosure of which is herein incorporated by reference in its entirety.

### BACKGROUND

### Field

The disclosure relates to a database (DB) processing technology, and more particularly, to a scheduling method in a DB environment in which a plurality of computational storage drives (CSDs) are used as a storage, which divides query computations and offloads (push down) to CSDs.

### Description of Related Art

In a query executing process, a database management system (DBMS) obtains data by scanning a query from a DB, filters obtained data, and returns only filtered data to a client.

However, when there is much data to be scanned in the DB, a large amount of data may be delivered from a storage in which the DB is established to the DBMS. To this end, a bandwidth is insufficient so that an overall response speed is reduced and power consumption increases.

As a solution to this problem, a storage of a DB may be implemented by a CSD which is capable of computing, such that a part of query computations is performed in the storage. However, there is almost no discussion of an effective scheduling method for offloading.

### SUMMARY

The disclosure has been developed in order to solve the above-described problem, and an object of the disclosure is to provide a method for effectively scheduling for optimal CSDs in dividing query computations and offloading in a DB environment in which a plurality of CSDs are used as a storage.

According to an embodiment of the disclosure to achieve the above-described object, a snippet scheduling method may include: collecting status information regarding CSDs constituting a DB system; receiving a snippet group for offloading a query received from a client to CSDs; selecting one of a plurality of scheduling polices; selecting a CSD to which snippets included in the group are delivered according to the selected scheduling policy; and delivering the snippets to the selected CSD, and the scheduling polices may be polices for selecting CSDs to which snippets are delivered, based on different criteria.

Selecting the CSD may include: when the selected scheduling policy is a first policy, selecting CSDs in which an SST file necessary for processing snippets is stored; and randomly designating one of the selected CSDs.

The status information may include at least one of a number of working blocks of a CSD, a data processing speed, a resource usage, a stored SST file list.

Selecting the CSD may include: when the selected scheduling policy is a second policy, selecting CSDs in which an SST file necessary for processing snippets is stored; scoring the selected CSDs with reference to a number of working blocks, a data processing speed, and a resource usage of the selected CSDs; and designating a CSD having a highest score.

The score may be proportional to the data processing speed of the CSD and may be inversely proportional to the number of working blocks and the resource usage.

Selecting the CSD may include: when the selected scheduling policy is a third policy, selecting CSDs in which an SST file necessary for processing snippets is stored; and designating a CSD that is not selected for other snippets among the selected CSDs.

The snippet scheduling method may include, when a plurality of CSDs are designated, designating a CSD that has the smallest number of working blocks.

The snippet scheduling method may further include, when reception of snippets fails, performing re-scheduling according to a selected scheduling policy.

Selecting one of the scheduling polices may include automatically selecting a scheduling policy according to an operating condition of the DB system.

According to another aspect of the disclosure, a DB system may include: a plurality of CSDs in which a DB is stored; and a DBMS configured to collect status information regarding CSDs, to receive a snippet group for offloading a query received from a client to CSDs, to select one of a plurality of scheduling polices, to select a CSD to which snippets included in the group are delivered according to the selected scheduling policy, and to deliver the snippets to the selected CSD, and the scheduling polices may be polices for selecting CSDs to which snippets are delivered, based on different criteria.

According to still another aspect of the disclosure, a snippet scheduling method may include: selecting one of a plurality of scheduling polices; selecting a CSD to which snippets included in a snippet group for offloading a query to CSDs are delivered according to the selected scheduling policy; and delivering the snippets to the selected CSD, and the scheduling polices may be polices for selecting CSDs to which snippets are delivered, based on different criteria.

According to yet another aspect of the disclosure, a DBMS may include: a snippet manager configured to generate a group of snippets for offloading a query to CSDs; and a snippet scheduler configured to select one of a plurality of scheduling polices, to select a CSD to which snippets included in a snippet group for offloading a query to CSDs are delivered according to the selected scheduling policy, and to deliver the snippets to the selected CSD, and the scheduling polices may be polices for selecting CSDs to which snippets are delivered, based on different criteria.

According to embodiments of the disclosure as described above, in a DB environment in which a plurality of CSDs are used as a storage, scheduling may be effectively performed for optimal CSDs in dividing query computations and offloading.

According to embodiments of the disclosure, various scheduling polices may be provided, and CSDs may be randomly selected according to user setting or a query execution environment, or an optimal CSD may be selected according to a CSD status or a content of an offload snippet, so that a query execution speed can be enhanced.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a DB system according to an embodiment of the disclosure;

FIG. 2 is a view illustrating a structure of a DBMS shown in FIG. 1;

FIG. 3 is a flowchart provided to explain a snippet scheduling method according to an embodiment of the disclosure;

FIG. 4 is a detailed flowchart of a random scheduling policy;

FIG. 5 is a detailed flowchart of a depends on CSD status (DCS) scheduling policy;

FIG. 6 is a view illustrating a DCS scheduling process;

FIG. 7 is a detailed flowchart of a SCI scheduling policy; and

FIG. 8 is a view illustrating a DCI scheduling process.

### DETAILED DESCRIPTION

Hereinafter, the disclosure will be described in more detail with reference to the accompanying drawings.

Embodiments of the disclosure propose a technology for effectively scheduling by operating a method of dividing query computations and offloading (push down) to CSDs in various ways in a DB system in which a plurality of CSDs are used as a storage.

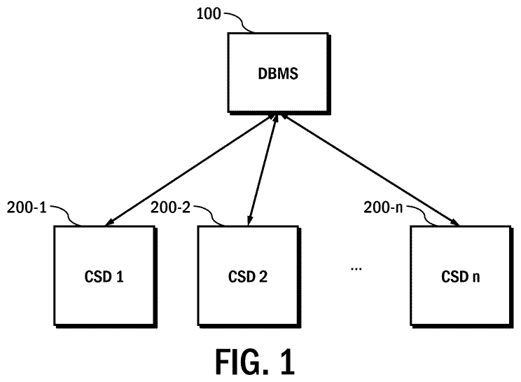

FIG. 1 is a view illustrating a DB system according to an embodiment of the disclosure. The DB system according to an embodiment may include a DBMS 100 and a plurality of CSDs 200-1, 200-1, . . . , 200-n as shown in FIG. 1.

The CSDs 200-1, 200-2, . . . , 200-n refer to storage systems in which all or a part of DB s is overlappingly established. A plurality of CSDs 200-1, 200-1, . . . , 200-n are implemented to process many queries which are requested simultaneously. Furthermore, the CSDs 200-1, 200-2, . . . , 200-n include a computational function, and may perform a part of query computations.

The DBMS 100 refers to a system that executes a query according to a request of a client (not shown) and returns a result. The DBMS 100 may not perform all of the query computations and may offload a part of the query computations to the CSDs 200-1, 200-2, . . . , 200-n.

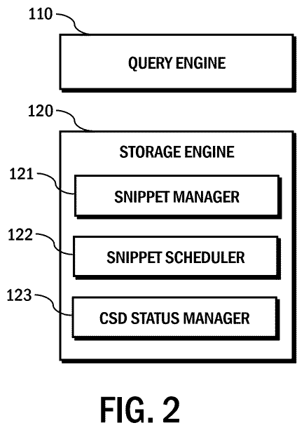

FIG. 2 is a view illustrating a structure of the DBMS 100 shown in FIG. 1. As shown in FIG. 2, the DBMS 100 may include a query engine 110 and a storage engine 120.

Upon receiving a query execution request from a client, the query engine 110 may optimize the received query and may deliver the query to the storage engine 120.

The storage engine 120 may offload a part of query computations to the CSDs 200-1, 200-2, . . . , 200-n. A part of the query computations may include query scanning, filtering, and validity examination.

To achieve this, the storage engine 120 may include a snippet manager 121, a snippet scheduler 122, and a CSD status manager 123.

The snippet manager 121 may generate a group of query computation offload snippets based on a query optimized by the query engine 110, and may deliver the generated snippet group to the snippet scheduler 122.

An offload snippet refers to an execution code on which a part of query computations that should be processed by a CSD, a block address of a file to be canned, a buffer address of the DBMS to store a result of computation is recorded, and will be referred to as a “snippet” hereinbelow. The CSD status manager 123 may periodically collect status information of the CSDs 200-1, 200-1, . . . , 200-n.

The snippet scheduler 122 may schedule snippets for optimal CSDs according to a scheduling policy set by a user. In order to follow a scheduling policy, snippet contents and CSD information may be referred to.

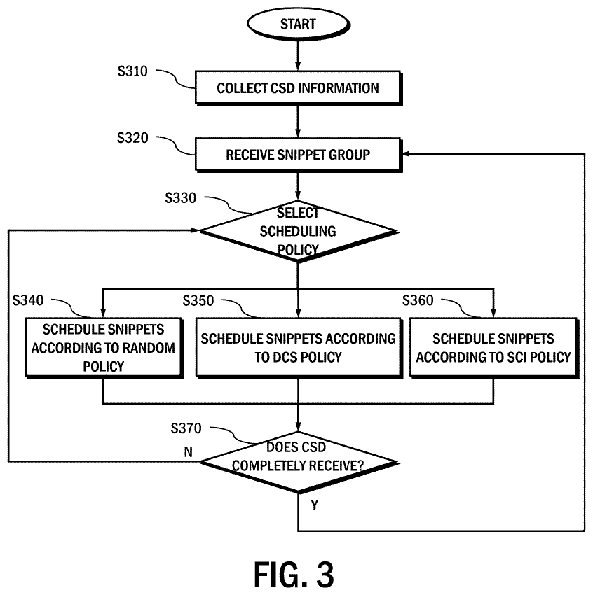

FIG. 3 is a flowchart provided to explain a snippet scheduling method according to an embodiment.

As shown in FIG. 3, the CSD status manager 123 may periodically collect information from the CSDs 200-1, 200-2, . . . , 200-n (S310). CSD information collected at step S310 may include a CSD IP, information on the presence/absence of a CSD replica, the number of working blocks, a data processing speed, metric data (resource usage, etc.), a stored state snapshot transfer (SST) file list.

When a snippet group is received from the snippet manager 121 (S320), the snippet scheduler 122 may select one of scheduling policies (S330). A scheduling policy may be selected according to setting of a user at step S330.

The scheduling policy may be divided into a random (default) scheduling policy (S340), a depends on CSD status (DCS) scheduling policy (S350), and a SCI scheduling policy (S360). A method for scheduling according to each policy will be described in detail.

When corresponding CSDs completely receive all snippets included in the group according to the selected scheduling policy (S370-Y), a next snippet group received from the snippet manager 121 may be scheduled.

On the other hand, when reception of snippets fails (S370-N), re-scheduling may be performed according to the selected scheduling policy. A CSD to which snippets are transmitted may be changed by re-scheduling.

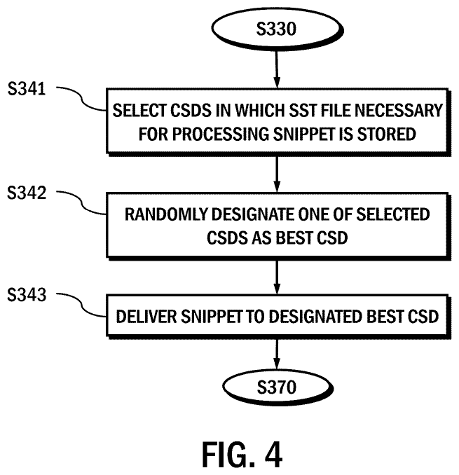

Hereinafter, the random scheduling policy performed through step S340 will be described in detail with reference to FIG. 4. FIG. 4 is a detailed flowchart of step S340.

As shown in FIG. 4, the snippet scheduler 122 may select CSDs in which an SST file necessary for processing snippets is stored by referring to an SST file list in the CSD information collected at step S310 (S341).

Next, the snippet scheduler 122 may randomly designate one of the CSDs selected at step S341 as a best CSD (S342), and may deliver snippets to the designated best CSD (S343).

Steps S341 to S343 may be performed for all snippets constituting a group, respectively.

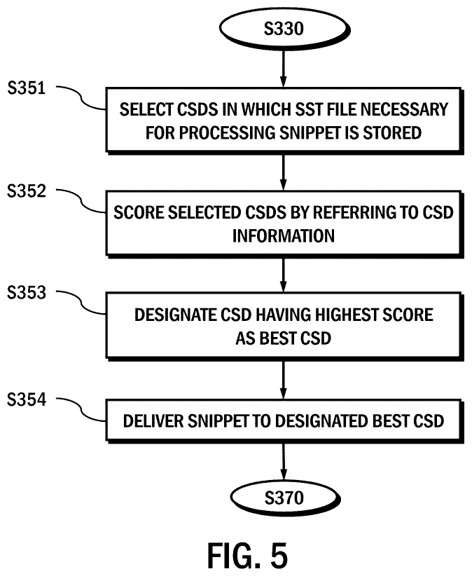

Hereinafter, the DCS scheduling policy performed through step S350 will be described in detail with reference to FIG. 5. FIG. 5 is a detailed flowchart of step S350.

As shown in FIG. 5, the snippet scheduler 122 may select CSDs in which an SST file necessary for processing snippets is stored by referring to an SST file list in the CSD information collected at step S310 (S351).

Next, the snippet scheduler 122 may score the CSDs selected at step S351 by referring to the number of working blocks, a data processing speed, metric data (resource usage, etc.) in the CSD information collected at step S310 (S352).

In addition, the snippet scheduler 122 may designate a CSD having a highest score as a best CSD (S353), and may deliver snippets to the designated best CSD (S354).

Steps S351 to S354 may be performed for all snippets constituting a group, respectively.

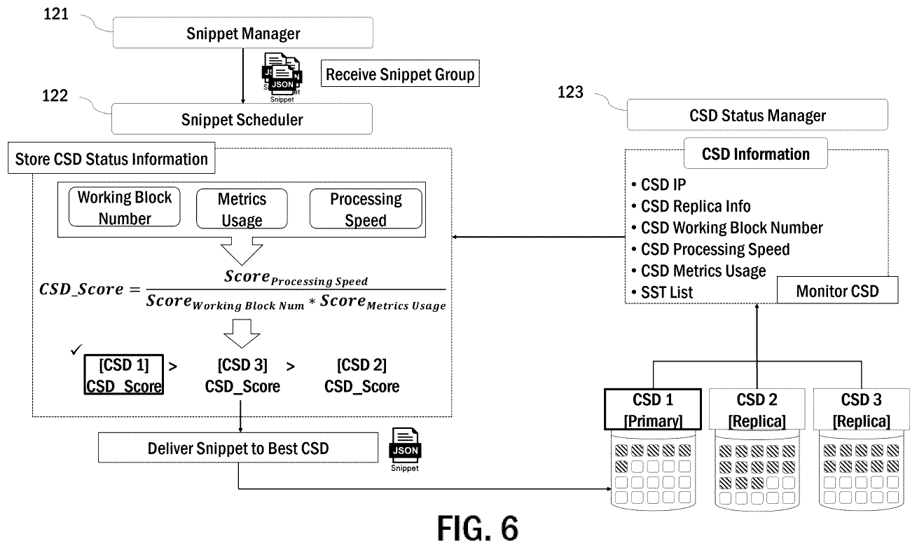

FIG. 6 illustrates a DCS scheduling process. As shown in FIG. 6, a CSD score may be calculated through the following equation:

$$CSD\_Score = \frac{{Score}_{Processing Speed}}{{Score}_{Working Block Num} * {Score}_{Metrics Usage}}$$

where CSD Score is a score of a CSD to be calculated, Score_{Processing Speed} is a score according to a data processing speed in a CSD, Score_{Working Block Num} is a score according to the number of working blocks in a CSD, and Score_{Metric Usage} is a score according to metric data (resource usage). As can be seen from the above equation, a score of a CSD is proportional to a data processing speed and is inversely proportional to the number of working blocks and metric data.

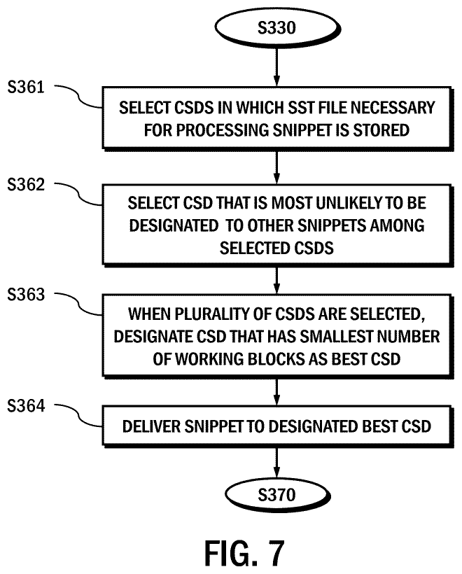

Hereinafter, a depends on snippet information (DSI) (SCI?) scheduling policy performed through step S360 will be described in detail with reference to FIG. 7. FIG. 7 is a detailed flowchart of step S360.

As shown in FIG. 7, the snippet scheduler 122 may select CSDs in which an SST file necessary for processing snippets is stored by referring to an SST file list in the CSD information collected at step S310 (S361). Herein, CSD selection should be performed for all snippets.

Next, the snippet scheduler 122 may select a CSD that is not selected for other snippets among the CSDs selected for each snippet (S362). This is to prevent a plurality of snippets from being concentrated on a CSD and an overload from occurring.

When a plurality of CSDs are selected at step S362, the snippet scheduler 122 may designate, as a best CSD, a CSD that has the smallest number of working blocks in the CSD information collected at step S310 (S363), and may deliver snippets to the designated best CSD (S364).

Steps S362 to 364 may be performed for all snippets constituting A group, respectively.

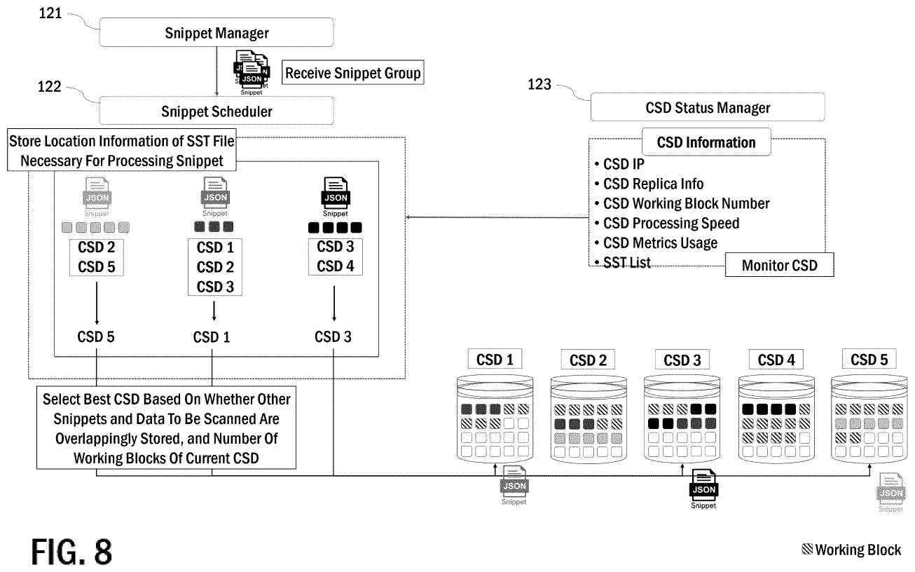

FIG. 8 illustrates a DCI scheduling process. As shown in the center of the left side of FIG. 8, a second snippet may be delivered to CSD 2 out of CSD 2, CSD 5 which process a first snippet. Accordingly, CSD 5 may be designated as a best CSD for the first snippet.

In addition, a third snippet may be delivered to CSD 3 among CSD 1, CSD 2, CSD 3 which process the second snippet. Accordingly, CSD 1 that has a smaller number of working blocks out of CSD 1 and CSD 2 (CSD 1 has a smaller number of working blocks, indicated in grey, than CSD 2 as shown in a lower portion of the right side of FIG. 8) may be designated as a best CSD for the second snippet.

In addition, CSD 3 that has a smaller number of working blocks out of CSD 3, CSD 4 which process the third snippet (CSD 3 has a smaller number of working blocks, indicated in grey, than CSD 4 as shown in a lower portion of the right side of FIG. 8) may be designated as a best CSD.

Up to now, a snippet scheduling method and a DB system applying the same have been described with reference to preferred embodiments.

In the above-described embodiments, a method of selectively operating various scheduling methods to divide query computations and to offload to CSDs in a DB system in which a plurality of CSDs are used as a storage has been proposed.

In the above-described embodiments, a scheduling method may be selected by setting of a user, but this is merely an example and changes may be made thereto. For example, a scheduling method may be automatically selected.

Specifically, optimal scheduling polices may be determined based on a present month/day/day of the week/time, and a scheduling policy may be automatically operated with reference to a high determination table.

Furthermore, when an average query processing speed is less than a defined speed for a predetermined time as a result of monitoring a current query processing speed, a scheduling policy may be automatically changed to another policy.

In addition, a scheduling policy may be automatically set according to a change in a query reception rate per unit time, that is, according to whether a query request increases or decreases.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A snippet scheduling method comprising:
collecting status information regarding CSDs constituting a DB system;
receiving a snippet group for offloading a query received from a client to CSDs;
selecting one of a plurality of scheduling polices;
selecting a CSD to which snippets included in the group are delivered according to the selected scheduling policy; and
delivering the snippets to the selected CSD,
wherein the scheduling polices are polices for selecting CSDs to which snippets are delivered, based on different criteria.

2. The snippet scheduling method of claim 1, wherein selecting the CSD comprises:
when the selected scheduling policy is a first policy, selecting CSDs in which an SST file necessary for processing snippets is stored; and
randomly designating one of the selected CSDs.

3. The snippet scheduling method of claim 1, wherein the status information comprises at least one of a number of working blocks of a CSD, a data processing speed, a resource usage, a stored SST file list.

4. The snippet scheduling method of claim 3, wherein selecting the CSD comprises:
when the selected scheduling policy is a second policy, selecting CSDs in which an SST file necessary for processing snippets is stored;
scoring the selected CSDs with reference to a number of working blocks, a data processing speed, and a resource usage of the selected CSDs; and
designating a CSD having a highest score.

5. The snippet scheduling method of claim 4, wherein the score is proportional to the data processing speed of the CSD and is inversely proportional to the number of working blocks and the resource usage.

6. The snippet scheduling method of claim 3, wherein selecting the CSD comprises:
when the selected scheduling policy is a third policy, selecting CSDs in which an SST file necessary for processing snippets is stored; and
designating a CSD that is not selected for other snippets among the selected CSDs.

7. The snippet scheduling method of claim 6, comprising, when a plurality of CSDs are designated, designating a CSD that has the smallest number of working blocks.

8. The snippet scheduling method of claim 1, further comprising, when reception of snippets fails, performing re-scheduling according to a selected scheduling policy.

9. The snippet scheduling method of claim 1, wherein selecting one of the scheduling polices comprises automatically selecting a scheduling policy according to an operating condition of the DB system.

10. A DB system comprising:
a plurality of CSDs in which a DB is stored; and
a DBMS configured to collect status information regarding CSDs, to receive a snippet group for offloading a query received from a client to CSDs, to select one of a plurality of scheduling polices, to select a CSD to which snippets included in the group are delivered according to the selected scheduling policy, and to deliver the snippets to the selected CSD,
wherein the scheduling polices are polices for selecting CSDs to which snippets are delivered, based on different criteria.

11. A snippet scheduling method comprising:
selecting one of a plurality of scheduling polices;
selecting a CSD to which snippets included in a snippet group for offloading a query to CSDs are delivered according to the selected scheduling policy; and
delivering the snippets to the selected CSD,
wherein the scheduling polices are polices for selecting CSDs to which snippets are delivered, based on different criteria.
